(19) United States
(12) Patent Application Publication
(10) Pub. No.: US 2021/0179403 A1
(43) Pub. Date: Jun. 17, 2021

(54) Omnidirectional Cart Transport Mechanism

(71) Applicant: SQUSE Inc., Kyoto-shi (JP)

(72) Inventors: Yoichiro Nakamura, Kyoto-shi (JP); Toru Takasaki, Kyoto-shi (JP); Yuya Wada, Kyoto-shi (JP)

(21) Appl. No.: 17/108,260

(22) Filed: Dec. 1, 2020

(30) Foreign Application Priority Data
Dec. 16, 2019 (JP) 2019-226567

(51) Int. Cl. B66F 9/06; B60K 7/00; G05D 1/02; B66F 9/18; B25J 9/16

(52) U.S. Cl. CPC B66F 9/063; B60K 7/0007; G05D 1/021; B25J 9/104; B25J 9/1633; B60K 2007/0038; G05D 2201/0216; B66F 9/18

(57) ABSTRACT

An omnidirectional cart transport mechanism includes an automatic guided vehicle that includes a drive wheel and a drive mechanism that drives the drive wheel, and travels on a road surface by driving the drive wheel using the drive mechanism, a side guide mechanism that includes a pair of side plates movable in a first direction of approaching or separating from each other, and guides a cart to be coupled to the automatic guided vehicle to a coupled position by bringing the pair of side plates closer to each other with the cart positioned between the pair of side plates, and a cart lift mechanism that lifts a coupled portion of the cart guided to the coupled position.

### CROSS-REFERENCE TO RELATED APPLICATIONS

This nonprovisional application claims priority under 35 U.S.C. § 119(a) on Patent Application No. 2019-226567 filed in Japan on Dec. 16, 2019, the entire contents of which are hereby incorporated by reference.

### FIELD

The present application relates to an omnidirectional cart transport mechanism capable of traveling while easily integrating a cart with an automatic guided vehicle (AGV) and easily uncoupling the cart from the AGV.

### BACKGROUND

Japanese Patent Application Laid-Open No. 2019-89493 discloses a drive wheel with a simple structure and a cart. The drive wheel disclosed herein comprises a first input bevel gear, a first driving unit for rotating the first input bevel gear and a second input bevel gear disposed opposite the first input bevel gear and rotatable around a rotary shaft of the first input bevel gear. The drive wheel further comprises a second driving unit for rotating the second input bevel gear, a first output bevel gear meshing with each of the first input bevel gear and the second input bevel gear and a wheel positioned at a spacing from the first output bevel gear. It further comprises a connection part connecting the first output bevel gear and the wheel and transmitting rotation of the first output bevel gear to the wheel, and a steering arm for rotating the connection part around the rotary shaft of the first input bevel gear.

Japanese Patent No. 6578063 discloses a towing device for an automatic guided vehicle and an automatic guided vehicle with the towing device. The automatic guided vehicle is provided with the towing device for preventing a decline in steerability when the automatic guided vehicle tows a cart. The towing device includes a connecting member having one end that is connected to the automatic guided vehicle swivelably (pivotally, rotatably) around the swivel (pivot, rotary, rotating, turning) shaft of the drive wheels and the other end that is connected to the cart.

Japanese Patent No. 3791663 discloses a drive wheel and a cart, and further discloses an omnidirectional vehicle including a body, a steering shaft attached to the body, an actuator for driving the steering shaft, a drive wheel, and an actuator for driving a drive wheel shaft, and further discloses the omnidirectional moving vehicle that may also be called a single wheel omnidirectional moving caster for driving the drive wheel with two motors.

Japanese Patent No. 5376347 discloses a steerable drive mechanism and an omnidirectional moving vehicle and makes a single wheel steerable by differential driving. The steerable drive mechanism includes a rotatable steering unit and a drive member rotating about an axis extending along a center axis of the steering unit. The steerable drive mechanism further includes an output shaft located at a position eccentric from the center axis of the steering unit and transmitting rotational force obtained from the drive member to the wheel.

Japanese Patent Application Laid-Open No. 2018-2320 discloses a traveling type transfer device which enables normal transfer regardless of shapes of packages. Disclosed here is a placement part on which a package is placed, an arm device including base arms provided at the placement part and extension arms which extend from the base arms to lateral sides of the package, and hooks provided at the tips of the extension arms.

Japanese Patent Application Laid-Open No. 2019-177836 discloses an automated guided vehicle that allows an operator to manually connect an object to the automated guided vehicle and to automatically move the object and automatically release the connected sate with the object.

### SUMMARY

An omnidirectional cart transport mechanism according to the present application relates to a technical concept disclosed in the above-described patent documents. For example, for a loading type AGV, dedicated equipment for loading or unloading is required. Meanwhile, for a tractor type AGV that tows a cart to be handled by an operator, a travel path with a wide area is required.

It is an object of the present application to provide a practical omnidirectional cart transport mechanism taking into account the dimensions of the cart that is currently used and the dimensions of a container to be loaded thereon, a housing box, a food tray, etc. while eliminating the need for a dedicated loading or unloading device and enabling the use of carts currently used by an operator as they are to carry various commodities and semi-finished products. Moreover, another object is to enable easy coupling (integration) of the cart to the AGV and uncoupling one from the other, and to further enable easy traveling and change of direction, for example, in a relatively narrow space.

In addition, another object is to provide an omnidirectional cart transport mechanism capable of securely and stably traveling even on a road surface with a puddle.

An omnidirectional cart transport mechanism according to one embodiment of the present application includes an automatic guided vehicle that includes a drive wheel and a drive mechanism for driving the drive wheel, and travels on a road surface by driving the drive wheel using the drive mechanism, a side guide mechanism that includes a pair of side plates movable in a first direction of approaching or separating from each other, and guides a cart to be coupled to the automatic guided vehicle to a coupled position by bringing the pair of side plates closer to each other with the cart positioned between the pair of side plates, and a cart lift mechanism that lifts a coupled portion of the cart guided to the coupled position.

In the omnidirectional cart transport mechanism according to the present application, it is possible to easily and surely integrate the automatic guided vehicle with the cart and release (uncouple) the integration regardless of their relatively simple structure and configuration. Furthermore, a turning radius during traveling that used to occur when an automatic guided vehicle tows a cart can be reduced, which eliminates the need for newly providing a wide travel lane specifically designed to the automatic guided vehicle and enables traveling in a relatively small passage through which a worker has conventionally passed for transporting a cart.

The above and further objects and features of the invention will more fully be apparent from the following detailed description with accompanying drawings.

### BRIEF DESCRIPTION OF DRAWINGS

FIG. 1 is an entire perspective view of an omnidirectional cart transport mechanism according to one embodiment of the present application.

FIG. 2 is a schematic diagram obtained when an automatic guided vehicle illustrated in FIG. 1 is viewed from the back.

FIG. 3 is a schematic diagram obtained when the omnidirectional cart transport mechanism illustrated in FIG. 1 is viewed from the bottom.

FIG. 4 is a top view of the omnidirectional cart transport mechanism illustrated in FIG. 1 viewed from the top when a side guide mechanism as a part thereof does not hold a cart.

FIG. 5 is a top view of the omnidirectional cart transport mechanism illustrated in FIG. 1 viewed from the top when the side guide mechanism as a part thereof holds the cart.

FIG. 6 is a schematic perspective view obtained when an automatic guided vehicle (AGV) as a part of the omnidirectional cart transport mechanism illustrated in FIG. 1 is viewed from the bottom to the top.

FIG. 7 is a schematic perspective view depicting a positional relation between the side guide mechanism and a cart lift mechanism according to the present application when both of the mechanisms are not activated.

FIG. 8 is a schematic perspective view depicting a positional relation between the side guide mechanism and the cart lift mechanism illustrated in FIG. 7 when the side guide mechanism is placed in an inactivated state while the cart lift mechanism is lifted and activated.

FIG. 9 is a schematic perspective view depicting a positional relation between the side guide mechanism and the cart lift mechanism illustrated in FIG. 7 when both of the mechanisms are activated.

FIG. 10 is a schematic side view depicting a positional relation between the cart lift mechanism and the cart when the cart lift mechanism illustrated in FIG. 7 is placed in an inactivated state.

FIG. 11 is a schematic side view depicting a positional relation between the cart lift mechanism and the cart when the cart lift mechanism illustrated in FIG. 10 is activated.

FIG. 12 is a schematic perspective view of an omnidirectional travel caster to be used in one embodiment of the present application.

FIG. 13 is a detailed perspective view illustrating the side guide mechanism illustrated in FIGS. 7 to 9.

FIG. 14 is a detailed perspective view illustrating the cart lift mechanism illustrated in FIGS. 7 to 11.

FIG. 15 is a table depicting examples of the dimensions of container carts (platform carts) that are currently used.

FIG. 16 is a table depicting examples of the dimensions of handle carts that are currently used.

FIG. 17 is a table depicting examples of the dimensions of containers that are currently used.

FIG. 18 is a schematic view illustrating a schematic posture when the omnidirectional cart transport mechanism illustrated in FIG. 1 goes straight and turns on a travel path.

FIG. 19 is a schematic diagram illustrating a behavior until the omnidirectional cart transport mechanism illustrated in FIG. 1 places loads in a preset container housing area.

### DESCRIPTION OF EMBODIMENTS

Before describing one embodiment of the present application, matters related to the present application are described in advance with reference to “vocabulary of automatic guided vehicle systems” defined by D6801:2019 Japanese Industrial Standards (JIS).

According to JIS D6801:2019, an “automatic guided vehicle” is defined as a vehicle that has a function of automatically traveling in a preset area and transporting products such as loads except for a person, and that is not used on a road defined by the Road Traffic Law.”

Furthermore, the “automatic guided vehicle” is classified into three: a general classification (1), a classification by a transfer system (2), and a classification by an automatic travel system (3).

Note that the above-described general classification (1) includes the following three types.

1101 Loader Type: this is a type of transporting a load placed on an automatic guided vehicle.

1102 Tractor Type: this is a type of transporting a load by towing a cart or a trolley on which a load is stacked. Some of the tractor types tow a cart like a train and others tow a cart from beneath.

1103 Fork Lift Truck Type: this is one of the loader type, and is provided with a fork for transfer and a mast for elevating or lowering the fork and is a type of transporting a load using them. The classification and the terms related to a forklift refer to JISD6201.

Moreover, the above-described classification by a transfer system (2) includes two types: an automatic transfer system and a manual transfer system while the above-described classification by an automatic travel system (3) includes three types: a path guide system, a self-navigation system and a target guided system.

The omnidirectional cart transport mechanism disclosed herein cannot be specified as any one of the three types of the above-described general classification (1) of the “automatic guided vehicle” and can be said to have all the functions of the three types as will be described later. Additionally, in terms of the above-described classification by an automatic travel system (3), this omnidirectional cart transport mechanism corresponds to the self-navigation system.

It is noted that a cart herein is “a platform with wheels for carrying products,” and the cart includes a platform cart without a hand-operated handle, a hand cart with a hand-operated handle, a foldable cart, a container cart on which a container for housing products therein is placed, a cage cart and the like.

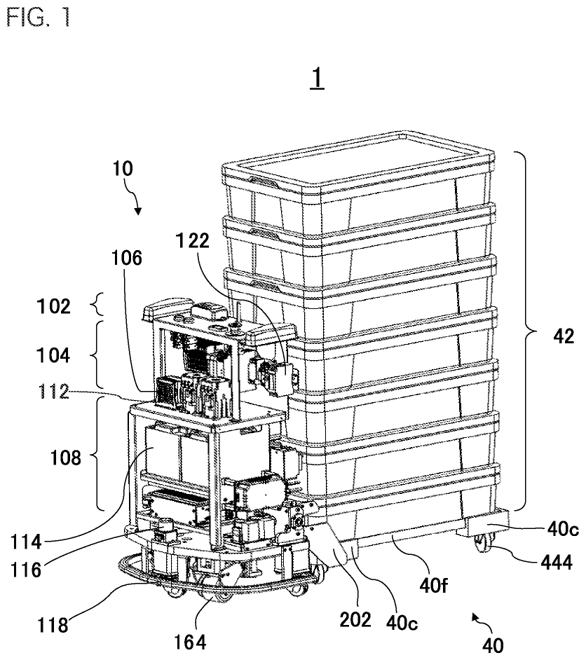

FIG. 1 is an entire perspective view of an omnidirectional cart transport mechanism 1 according to one embodiment of the present application. Broadly speaking, the omnidirectional cart transport mechanism 1 includes an automatic guided vehicle (hereinafter referred to as an AGV) 10, a cart 40 and an integration mechanism (side guide mechanism 20 and cart lift mechanism 30 to be described later) for integrating the AGV 10 with the cart 40. The integration mechanism will be described later. The cart 40 illustrated in FIG. 1 is generally called a platform cart or a container cart, which is a so-called cart without a hand-operated handle. Briefly discussing the structure and/or configuration of the cart 40, the cart 40 is constructed by a combination of a frame member 40f and corner members 40c provided with cart casters 444, and is substantially quadrangular in plan view. On the cart 40, several number of stacked containers (including pallets, trays, food trays, or the like) 42 are loaded. Each of the container 42 contains various commodities such as foods and industrial products, semi-finished products thereof, raw materials, etc.

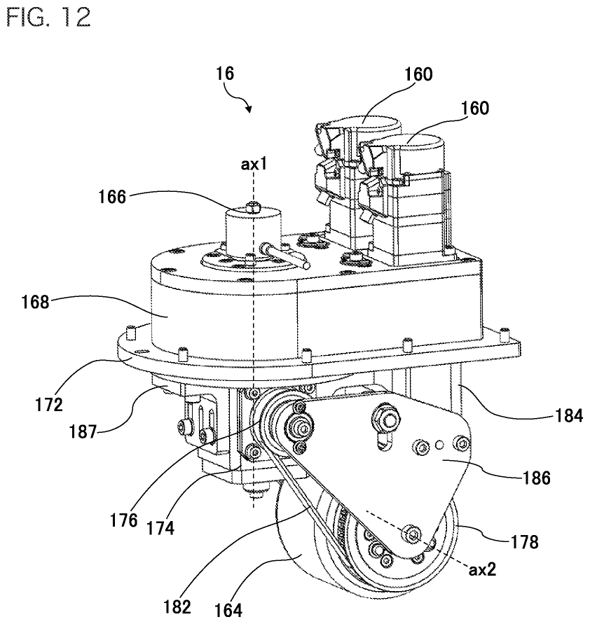

The AGV 10 includes an operation/display unit 102, a control unit 104, a controller 106, a power supply unit 108, an electromagnetic contactor 112, a battery 114, a laser distance sensor 116, a bumper switch 118, a power switch 122, a drive wheel 164, etc. The drive wheel 164 is a wheel rotated by transmission of power output from servo motors 160 (see FIG. 12) to be described later to cause the AGV 10 to travel. The drive wheel 164 is an omnidirectional moving wheel, and is driven by the servo motors 160 to cause the AGV 10 to travel.

The operation/display unit 102 is disposed at the upper part of the AGV 10, and is further provided with an antenna and a wireless module for performing wireless control as well as a battery gauge, a direction indicator, an emergency stop button and the like. The operation/display unit 102 is most often used by a worker or an operator of the AGV 10.

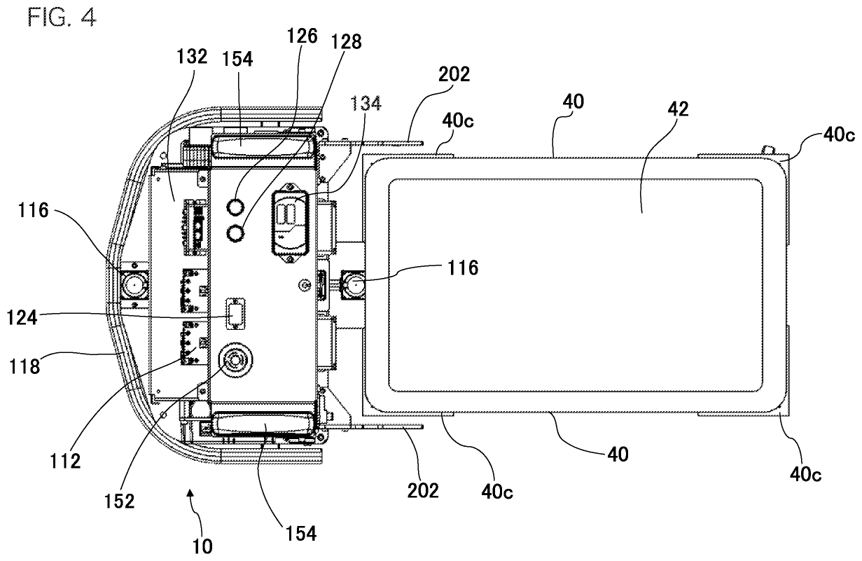

The control unit 104 includes the controller 106, the electromagnetic contactor 112, etc. The controller 106 is constituted by a one-chip microcomputer, for example, and is provided with a microprocessor for processing information, a memory for storing information, an interface for exchanging information with an external device and the like. The controller 106 stores or registers map information and distance information previously storing information on a traveling route and a traveling distance, a traveling premises, a specific object within a building, etc. Furthermore, it can record or display the traveling route up to now and the current position of the omnidirectional cart transport mechanism 1, and can further estimate a traveling route and a traveling distance up to a final destination. It is noted that the controller 106 has a function of issuing an instruction signal for controlling the rotation of the servo motors 160 (see FIG. 12) as power sources of an omnidirectional moving caster 16 and for automatically coupling the AGV 10 to the cart 40 or uncoupling the AGV 10 from the cart 40 on the basis of detection information detected by the laser distance sensor (range sensor) 116 illustrated in FIG. 1, a detection signal detected by a sensor (laser distance sensor 116 between the AGV 10 and the cart 40 depicted in FIG. 4) installed at the bottom of the omnidirectional cart transport mechanism 1, and a signal output from an encoder 166 (see FIG. 12) for detecting a rotational position (angle) of the omnidirectional moving caster 16 (see FIG. 12).

The electromagnetic contactor 112 is used for starting or stopping the motor as a driving source of the AGV 10.

The power supply unit 108 has a charging device (not illustrated) or the like other than the battery 114.

The laser distance sensor 116 is also called a range sensor, and emits a laser beam during traveling to the surroundings, receives the light reflected from objects around it such as a wall, a pillar or various installations, and measures the distance with each of the objects around it based on the time of flight.

The bumper (cable) switch 118 is formed in a U shape, for example, at the lower part of the AGV 10, and is one of pressure-sensitive switches with conductivity and resilience for detecting contact and collision.

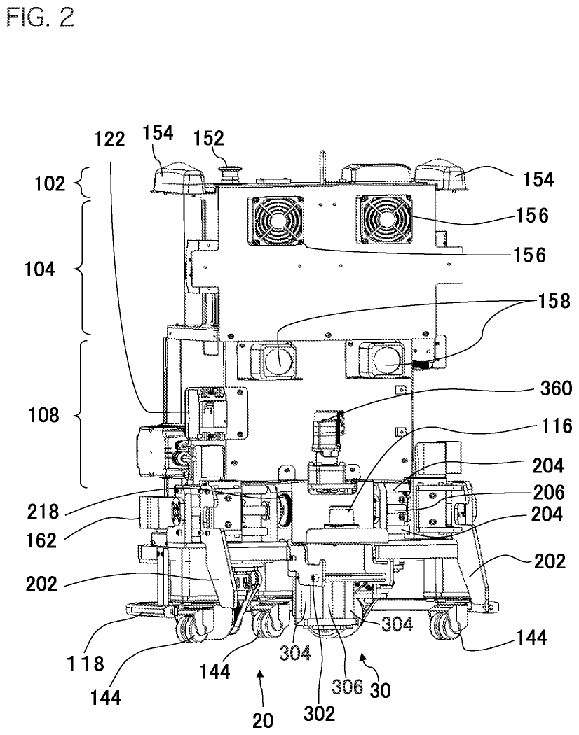

FIG. 1 illustrates a positional relation between the AGV 10 and the cart 40. Only the side plates 202 forming integral parts of the side guide mechanism 20 (see FIG. 2) thus can be viewed out of the integration mechanism for integrating the AGV 10 with the cart 40. The integration mechanism will be described later.

FIG. 1 illustrates the AGV 10 from which a housing is removed for representing the outline of the internal structure/configuration thereof. The housing has a substantially rectangular parallelepiped shape, and is, for example, 600 mm wide, 400 mm deep and 900 mm high. The width here indicates the length in the direction orthogonal to the direction of progress of the AGV 10. The depth is the length in the direction the same as the direction of progress of the AGV 10. The height of 900 mm indicates the length from the position where the drive wheel 164 contacts a travel path (road surface) to the highest position (the end of the antenna, for example) of the operation/display unit 102. Especially, the dimensions of the width and the depth of the AGV 10 are decided by taking into account the dimensions of the cart 40 to be coupled and the dimensions of the container 42 to be loaded on the cart 40. Alternatively, if the AGV 10 is accompanied by a worker, the width and the depth of the AGV 10 are selected such that the worker can easily recognize the surrounding condition of the AGV 10 and the surrounding condition of the cart 40 to be coupled to the AGV 10. The details will be described later. Furthermore, the height of the AGV 10 is selected such that the worker/operator can easily operate or touch the region of the operation/display unit 102.

FIG. 2 is a schematic diagram obtained when the AGV 10 illustrated in FIG. 1 is viewed from the back. The cart 40 is coupled to the back side of the AGV 10. The same parts as FIG. 1 are denoted by the same reference codes.

The operation/display unit 102 is provided with an emergency stop button 152 and direction indicators 154 that are not denoted by reference codes in FIG. 1. The emergency stop button 152 is prepared so as to allow the accompanying operator to urgently stop the operation when the omnidirectional cart transport mechanism 1 itself has any trouble, or if the omnidirectional cart transport mechanism 1 has a trouble in traveling due to the change in the surrounding environment. The direction indicators 154 display the direction of travel of the omnidirectional cart transport mechanism 1 or the quality of the traveling condition. The direction indicator 154 can be constituted by LEDs of a single color or multiple colors, for example.

In FIG. 2, fans 156 are mounted on the back side of the control unit 104 illustrated in FIG. 1 while speakers 158 are mounted on the reverse side of the power supply unit 108 illustrated in FIG. 1. The fan 156 is prepared to be used for ventilating and cooling the entire interior of the AGV 10. The speaker 158 is one of the sound transmission means for reporting a situation in which another AGV or a device approaches the omnidirectional cart transport mechanism 1 with sounds such as a beeper, a chime, a melodic pattern or the like.

FIG. 2 illustrates integral parts of the members forming the side guide mechanism 20 and the cart lift mechanism 30 that fail to be displayed in FIG. 1. The side guide mechanism 20 includes a pair of side plates 202 and a gear mechanism 218. The cart lift mechanism 30 includes hooks 302, slide shafts 304 and a servo motor 360. Each mechanism is configured to organically connect these members with other members, though the details thereof will be described later.

FIG. 2 depicts a servo driver 162 for controlling the pair of servo motors 160 to drive the drive wheel 164 and driven casters 144, etc. other than the side guide mechanism 20 and the cart lift mechanism 30. Unlike the drive wheel 164, the driven caster 144 is a wheel to which power from the servo motor or the like is not transmitted and rotated in accordance with traveling of the AGV 10.

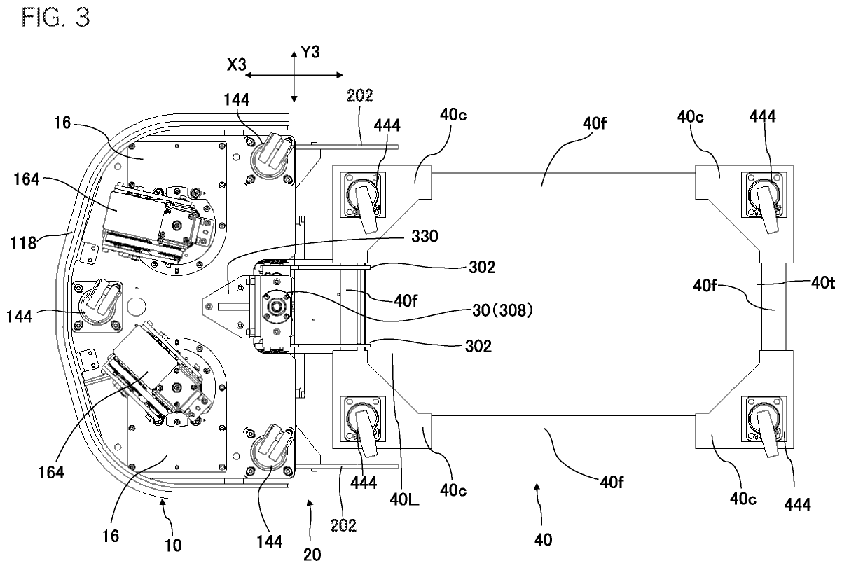

FIG. 3 is a schematic diagram when the omnidirectional cart transport mechanism 1 illustrated in FIG. 1 is viewed from the bottom. In FIG. 3, the members the same as those in FIGS. 1 and 2 are denoted by the same reference codes. The AGV 10 is provided with a pair of omnidirectional moving casters 16, and the drive wheels 164 are integral components of the respective omnidirectional moving casters 16. The omnidirectional moving caster described herein is one of the holonomic vehicles suggested in Japanese Patent No. 3791663 described before. The vehicle is capable of simultaneously and independently controlling the traveling velocity in the direction of progress and the lateral direction of the vehicle as well as the angular velocity about a vertical axis of the vehicle (change of the posture of the vehicle). The outline of the structure and configuration of the omnidirectional moving caster 16 will be illustrated in FIG. 12 to be described later.

The AGV 10 is slightly rounded on the front, that is, on the bumper switch 118 side while being substantially flat on the back opposite to the front, and thus the contour of the AGV 10 can be said to be substantially quadrangular in plan view.

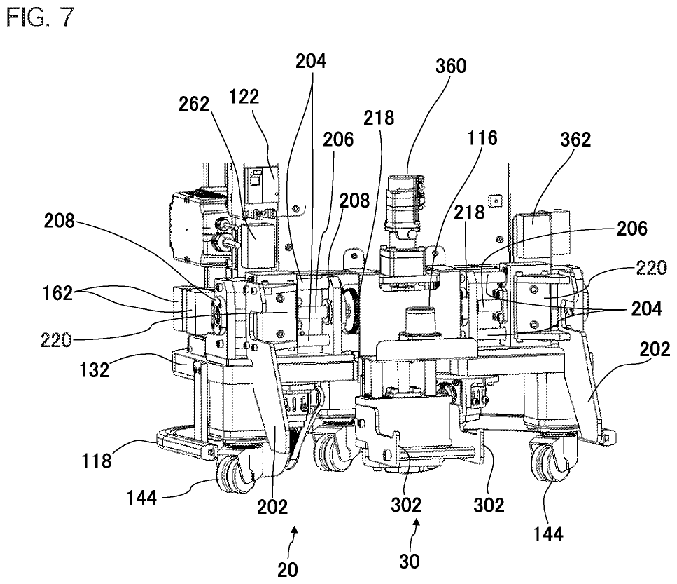

In FIG. 3, the side guide mechanism 20 is attached to the AGV 10 as illustrated in FIGS. 7-9 to be described later. The pair of side plates 202 as integral parts of the side guide mechanism 20 extend to the both side portions of the cart 40 extending in the direction the same as the traveling direction X3 of the AGV 10. The side plates 202 are applied to a part of the corner members 40c in a longitudinal direction (long length direction) of the cart 40, and abut against the both side portions of the cart 40 so as to hold the side portions therebetween during traveling and uncouple the parts of the both side portions of the cart 40 during non-traveling.

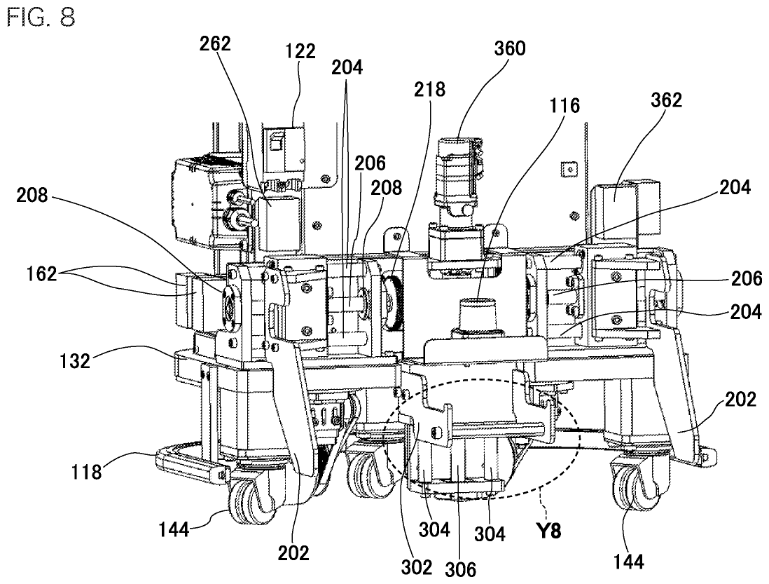

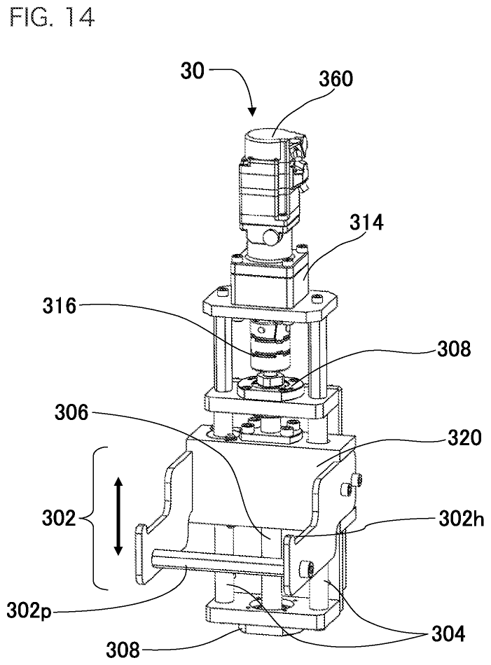

In FIG. 3, a cart lift connection base 330 being a base portion of the cart lift mechanism 30 is attached to the central edge of the AGV10 in an orthogonal direction Y3 orthogonal to the traveling direction X3. The main body of the cart lift mechanism 30 is installed upright on the cart lift connection base 330 from the near side to the far side of the paper of the drawing (see FIGS. 14 and 8). Hooks 302 forming integral parts of the cart lift mechanism 30 extend from the side edges of the cart lift connection base 330 toward a central portion (coupled portion) of the frame member 40f of the cart 40. Upon starting or traveling of the omnidirectional cart transport mechanism 1, the hooks 302 of the cart lift mechanism hook and slightly lift the coupled portion (not depicted) constituted by an aperture or a groove as a part of the frame member 40f. If lifting by the hooks 302 is made too high, the tilt between a leading end portion 40L (coupled portion) and a trailing end portion 40t of the cart 40 is steep, to thereby cause an unfavorable difference in height between the front and rear cart casters 444. Accordingly, the hooks 302 have to lift the cart 40 high enough to absorb the difference in height that can be caused between the front and rear wheels by resilience the cart casters 444 originally have. It is noted that the cart does not necessarily travel with the leading end portion 40L of the cart 40 ahead, but the cart may travel with the trailing end portion 40t ahead of the leading end portion 40L. In any event, the hooks 302 lift a region of the cart 40 close to the AGV 10.

The cart 40 depicted in FIG. 3 is substantially quadrangular in plan view, though having some projections and depressions when partially viewed. The cart 40 depicted in FIG. 3 is long along the traveling direction X3 while being short along the orthogonal direction Y3. Generally, the cart have different length in the longitudinal and lateral directions to often have a substantially quadrilateral shape, though such length is dependent on the container to be loaded thereon. The cart 40 is constituted by the corner members 40c that connect both of the frame members 40f in a quadrilateral shape, the four cart casters 444 pivotally supported on the corner members 40c, etc.

FIG. 4 is a top view obtained when the omnidirectional cart transport mechanism 1 illustrated in FIG. 1 is viewed from a side opposite to that in FIG. 3, that is, from the top (operation/display unit 102 side) to the bottom (drive wheel 164 side), and when the pair of side plates 202 do not hold the side surfaces of the cart 40. The members the same as those in FIGS. 1-3 are denoted by the same reference codes. FIG. 4 depicts the electromagnetic contactor 112, a battery gauge 124 for displaying remaining voltage of a battery, an operation start button 126, a reset button 128, a wireless module 134, the emergency stop button 152, the direction indicators 154, etc. FIG. 4 depicts a state in which the side plates 202 are slightly spaced apart from the corner members 40c of the cart 40 without abutting against them. This situation depicts a non-transportation state in which the integration function of the AGV 10 with the cart 40 is released.

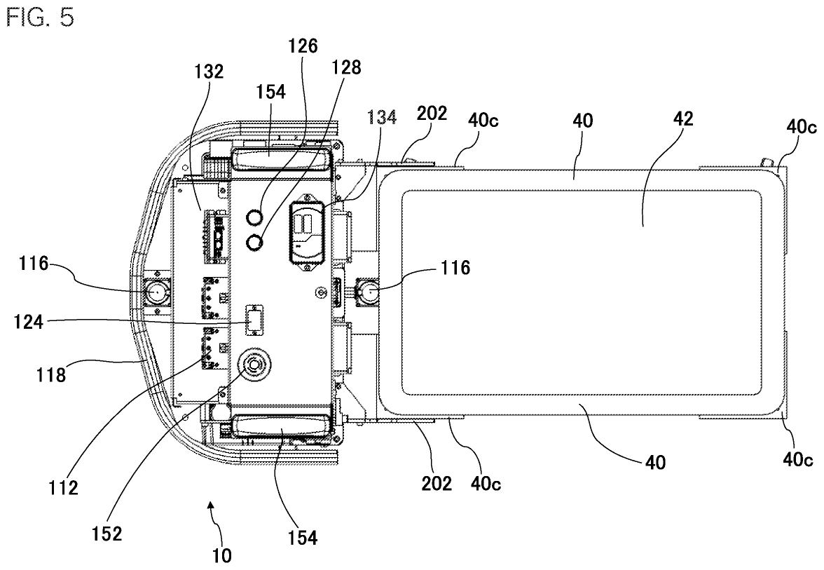

FIG. 5 is a top view obtained when the omnidirectional cart transport mechanism illustrated in FIG. 1 is viewed from the side opposite to that in FIG. 3 similarly to FIG. 4, that is, from the top. The members the same as those in FIGS. 1-4 are denoted by the same reference codes. FIG. 5 is different from FIG. 4 in that the pair of side plates 202 abut against the side surfaces of the cart 40. This is a state where the AGV 10 and the cart 40 are integrated with each other, and this situation is brought about when the omnidirectional cart transport mechanism 1 travels.

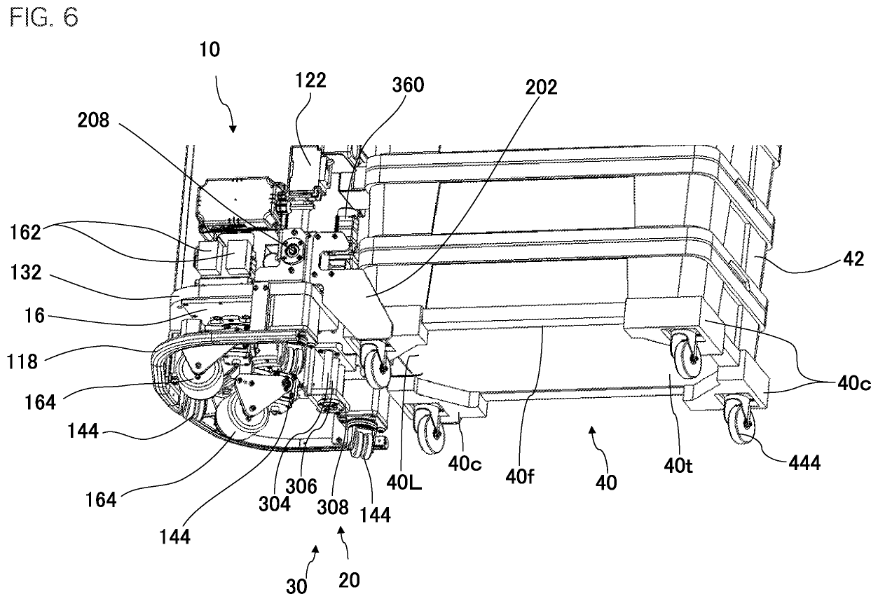

FIG. 6 is a schematic perspective view obtained when the omnidirectional cart transport mechanism 1 illustrated in FIG. 1 is viewed from the bottom to the top. FIG. 6 is also a perspective view when the omnidirectional cart transport mechanism 1 illustrated in FIG. 3 is viewed from the near side to the much farther side of the paper of the drawing. In FIG. 6, the members the same as those in FIGS. 1-5 are denoted by the same reference codes. The overlapped members will not be described while the members only displayed in FIG. 6 will be described here.

The pair of servo drivers 162 are used for the pair of servo motors 160 to be described later respectively, and drive the servo motors 160 in accordance with an instruction from the controller 106. It is noted that the servo motors 160 are motors as power sources for driving the drive wheels 164 (omnidirectional moving casters 16). A base plate 132 is a platform for being mounted with the laser distance sensor 116 or for supporting a bracket mounted with the controller 106, the electromagnetic contactor 112, the battery 114, etc. The slide shafts 304 are sliding shafts that allow the hooks 302 (see FIG. 7) forming integral parts of the cart lift mechanism 30 to move upward or downward. A bearing 308 is a support member that allows a feed screw 306 (see FIG. 14) forming a part of the cart lift mechanism 30 to rotate. The feed screw 306 extends or shortens the distance between the pair of side plates 202 in the right-left direction. The servo motor 360 (see FIGS. 7 and 14) is a driving source for the cart lift mechanism 30.

FIG. 7 is a schematic perspective view of the AGV 10 illustrated in FIG. 1 when viewed from the back (see FIG. 2) to the front, that is, the bumper switch 118 side. The schematic perspective view is partially overlapped with that in FIG. 2. The members the same as those in FIGS. 1-6 are denoted by the same reference codes. FIG. 7 more clearly depicts the integration mechanism for integrating the AGV 10 with the cart 40, that is, the positional relation between the side guide mechanism 20 and the cart lift mechanism 30. It is noted that the positional relation in FIG. 7 depicts a state in which the integration function is released, specifically, the distance between the pair of side plates 202 is farthest in the right-left direction while the hooks 302 are moved downward to the lowest position and are not coupled to the cart 40 or do not lift the cart 40.

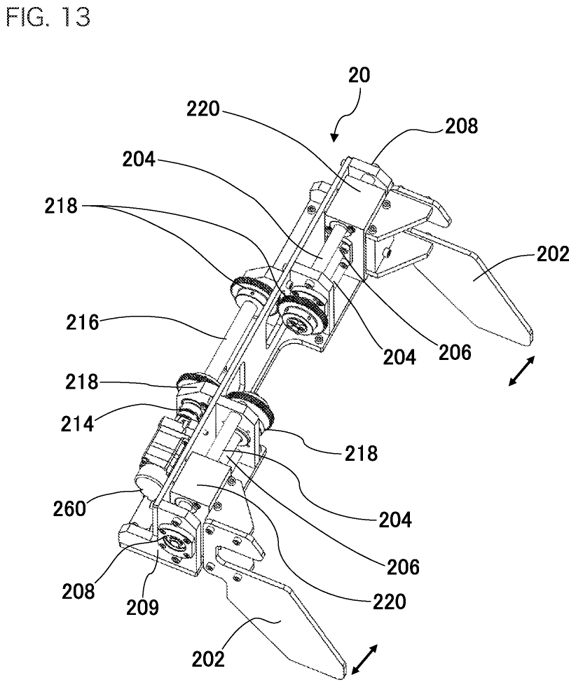

The side guide mechanism 20 is separately disposed on both sides of the cart lift mechanism 30 such that the side plates 202 are applied to the both side surface portions in the longitudinal direction of the cart 40 as illustrated in FIGS. 3-5. FIG. 7 depicts the side plates 202, slide shafts 204, feed screws 206, bearings 208, the gear mechanism 218, nut portions 220 and a servo driver 262 that form parts of the side guide mechanism 20. The servo driver 262 controls the servo motor 260 (see FIG. 13). The members directly abut against the cart 40 among the side guide mechanism 20 are the pair of side plates 202 and 202. The feed screw 206, the nut portion 220 and the like are prepared in order to perform conversion to a linear-motion for extending or shortening the distance between the pair of side plates 202 in the lateral direction (short length direction) of the cart 40.

It is noted that FIG. 7 does not depict all the members forming the side guide mechanism 20. The entirety of the side guide mechanism 20 will be illustrated in FIG. 13 to be described later. The control of the movement of the side plates 202 in the right-left direction (direction in which the pair of side plates 202 and 202 approach or depart from each other) is performed by controlling the servo driver 262 in accordance with an instruction from the controller 106 and driving the servo motor 260 by the servo driver 262. Here, the side guide mechanism 20 illustrated in FIG. 7 is in an inactivated state in which the side plates 202 do not abut against the cart 40.

Now, FIG. 7 illustrates the hooks 302, the servo motor 360 and a servo driver 362 that form integral parts of the cart lift mechanism 30. The servo driver 362 is used with the servo motor 360 in a pair, and drives the servo motor 360 in accordance with an instruction from the controller 106. It is noted that the cart lift mechanism 30 also includes the slide shafts 304, etc. depicted in FIG. 6, which are not denoted by the reference codes in FIG. 7 for the sake of brevity. The entirety of the side guide mechanism 20 will be illustrated in FIG. 13 to be described later.

FIG. 8 is a schematic perspective view when only the hooks 302 forming the cart lift mechanism 30 are lifted upward in the side guide mechanism 20 and the cart lift mechanism 30 illustrated in FIG. 7, that is, when the cart lift mechanism 30 is activated. In FIG. 8, the members the same as those in FIG. 7 are denoted by the same reference codes.

FIG. 8 is different from FIG. 7 in the region denoted by a reference code Y8 in which the hooks 302 slightly move upward in comparison with FIG. 7. This is a state where the hooks 302 are hooked on the central edge of the cart 40 to integrate the AGV 10 with the cart 40. The control of the upward and downward movement of the hooks 302 is performed by controlling the servo driver 362 in accordance with an instruction from the controller 106 and driving the servo motor 360 by the servo driver 362.

The cart lift mechanism 30 slightly lifts the AGV 10 side of the cart 40, not the entire cart 40, relative to the road surface while hooking in the vicinity of the central edge (not illustrated) of the short length direction of the cart 40 with the hooks 302. This causes a part of the entire weight including the cart 40 and the container 42 to be loaded thereon to be applied to the cart lift mechanism 30 as a reaction force. This application of the reaction force increases the frictional force between the drive wheels 164 and the road surface. In other words, the grip force of the drive wheels 164 on the road surface is increased, which can reduce or eliminate skidding of the omnidirectional cart transport mechanism 1 on a travel path.

Assuming that the entire weight including the cart 40 and the container 42 to be loaded thereon is 200 kg, for example, the weight to be applied to the cart lift mechanism 30 as reaction force is a maximum of approximately 40 kg, for example. That is, approximately 20% of the entire weight may be used as a guide.

Generally, in the case where an AGV is configured to carry multiple containers containing commodities, semi-finished products or the like placed on the cart, the drive wheels of the AGV may be skidded if the weight of the transported products is great relative to the weight of the AGV. The cart lift mechanism 30 according to the present application can avoid such a problem. In addition, lifting up by the hooks 302 enables secure coupling to the cart 40, which enhances the integration function of the AGV 10 with the cart 40.

In other words, the cart lift mechanism 30 has two functions of the integration mechanism of integrating the AGV 10 with the cart 40 and a skid prevention mechanism.

Now, when the two wheels of the cart casters 444 positioned closer to the AGV 10, that is, on the leading end portion 40L side illustrated in FIG. 3 are completely separated from the road surface, the load of the transported products is concentrated on the two wheels of the cart casters 444 positioned farthest from the AGV 10, that is, closer to the trailing end portion 40t, so that these two wheels may be easily damaged or have difficulties in traveling. Therefore, the cart lift mechanism 30 is set such that reaction force of approximately 20% of the weight of the transported products is applied to the drive wheels 164 as described above. More specifically, the lifting force by the cart lift mechanism 30 is provided based on a target torque set value or a set value of the limitation of torque of the servo motor 360 moving the cart lift mechanism 30. These set values can be set on the basis of the weight of the AGV 10 itself, the total transport weight including the cart 40, the structure, the material property and the dimensions of the servo motor 360 or the drive wheel 164, or a towing force with which the AGV 10 can tow, or the like.

The cart lift mechanism 30 including the hooks 302 is positioned at an intermediate portion between the pair of side plates 202. The pair of side plates 202 are members for being brought into abutment against the both side surfaces of the cart 40. This requires a certain amount of spaced portion between the pair of side plates 202. The cart lift mechanism 30, especially the hook 302 moving upward and downward, is positioned in the spaced portion, which can make the AGV 10 compact.

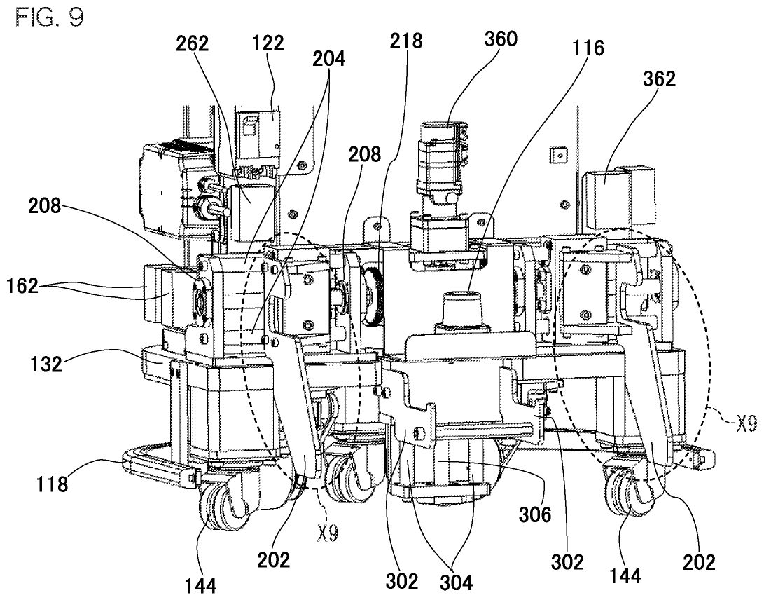

FIG. 9 is a schematic perspective view depicting regions when the side guide mechanism 20 illustrated in FIG. 7 is placed in an activated state, and the pair of side plates 202 hold the both side portions of the cart 40 therebetween, and further depicting a state where the hooks 302 of the cart lift mechanism 30 are raised upward to lift the cart 40. In FIG. 9, the members the same as those in FIGS. 7 and 8 are denoted by the same reference codes. FIG. 9 is different from FIG. 8 in that the side plates 202 are slightly closer to the hook 302 side as depicted by the regions denoted by a reference code X9.

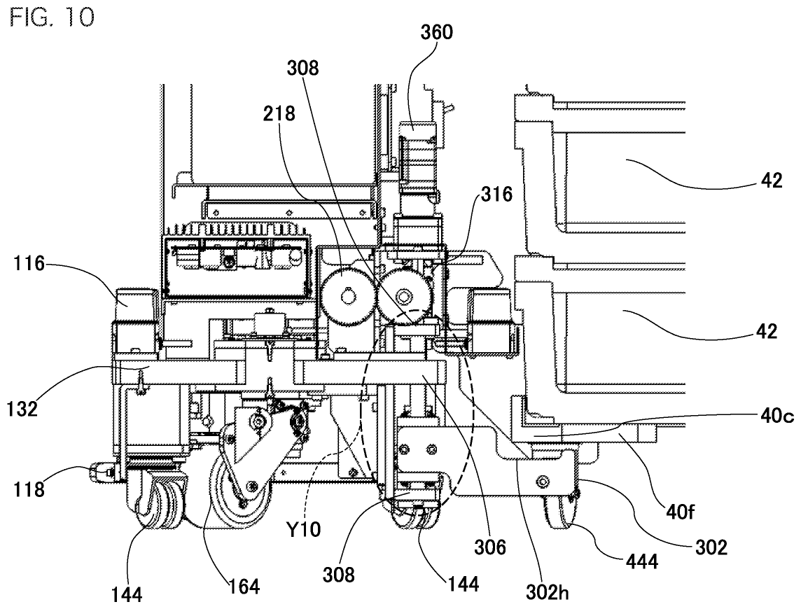

The horizontally movable distance of the pair of side plates 202 is approximately several tens of mm, and the actual travel distance is decided by the length of the cart 40 in the short side direction. Meanwhile, the vertically movable distance of the hook 302 is decided by the distance from the road surface to the frame member 40f of the cart 40 illustrated in FIG. 10. As described before, the hooks 302 slightly lift one side of the cart 40 closer to the short length direction until the torque of the servo motor 360 reaches the set value, so that the reaction force is applied to drive wheels 164 of the AGV 10. This offers advantages of increasing the frictional force with the road surface of the travel route and preventing a skid of the drive wheels 164. Moreover, the hooks 302 are placed a little higher than a region of the cart 40, and thus even if the cart 40 and the AGV 10 swing during traveling of the omnidirectional cart transport mechanism 1, the hooks 302 and the cart 40 are securely coupled to each other.

FIG. 10 is a schematic view depicting a positional relation between the cart lift mechanism 30 and the cart 40 according to the present application when the cart lift mechanism 30 does not lift the cart 40, that is, when the hooks 302 of the cart lift mechanism 30 move downward. FIG. 10 is a drawing illustrating the cart lift mechanism 30 illustrated in FIG. 7 plus the cart 40 to be coupled thereto, and viewed from an angle different from that in FIG. 7. The members the same as those in FIGS. 1-9 are denoted by the same reference codes.

The members forming the cart lift mechanism 30 illustrated in FIG. 10 include the hook 302, the feed screw 306, the bearings 308, a shaft coupling 316, and the servo motor 360.

The rotational motion generated by the servo motor 360 is converted into linear-motion for moving the hook 302 upward and downward by the feed screw 306 via the shaft coupling 316. FIG. 10 depicts a state in which neither the frame member 40f nor the corner member 40c of the cart 40 abuts against a hook concavity 302h of the hook 302. In FIG. 10, the presence of another corner member 40c on the far side of the paper of the drawing other than the corner member 40c on the near side of the paper of the drawing is apparent from FIG. 3, etc. The hooks 302 generally hook the central portion of the frame member 40f, and it is observed that neither the hook concavity 302h nor the both side surfaces of the concavities abut against the central portion of the frame member 40f.

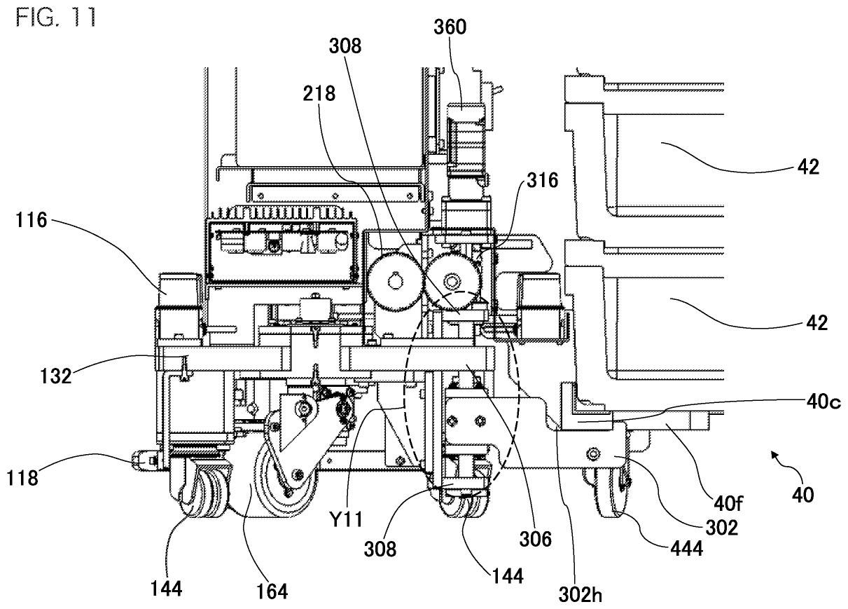

It is noted that the region depicted by a reference code Y10 is prepared to compare the upward and downward movement of the hook 302 with that in FIG. 11 to be described later. FIG. 10 depicts that the hook 302 is closer to the lower bearing 308 side.

FIG. 11 is a schematic view depicting a positional relation between the cart lift mechanism 30 and the cart 40 according to the present application when the cart lift mechanism 30 lifts the cart 40, that is, when the cart lift mechanism 30 is activated. The omnidirectional cart transport mechanism 1 starts and travels in the state illustrated in FIG. 11 when carrying transported products.

FIG. 11 depicts a state in which the hook 302 hooks the central portion of the frame member 40f. Here, in FIG. 11, though the hook 302 appears to abut against the corner member 40c at a first glance, the object to be hooked is in the vicinity of the central portion (coupled portion) of the frame member 40f of the cart 40 positioned at the back of the AGV 10 as can be understood from FIG. 3.

FIG. 11 is different from FIG. 10 only in the region denoted by a reference code Y11. FIG. 11 depicts that the hook 302 is moved upward to a substantially intermediate position between the upper bearing 308 and the lower bearing 308 as compared with FIG. 10. In any event, the distance to be moved upward or downward by the hook 302 is equal to or less than several tens of millimeters.

FIG. 12 is a schematic perspective view of the omnidirectional travel caster 16 to be used in one embodiment of the present application. As illustrated in FIG. 3, the omnidirectional moving caster 16 illustrated in FIG. 12 is prepared in a pair (two wheels), and each of the moving casters 16 is secured to the base plate 132 (see FIGS. 7 and 8) of the AGV 10 via a mounting plate 172.

The respective servo motors 160 are used with the servo drivers 162 depicted in FIG. 6 and FIG. 7 in pairs and are operated in accordance with an instruction from the controller 106.

In FIG. 12, an axis ax1 and an axis ax2 are virtual axes provided for illustrative purpose, and the axis ax1 coincides with the axis of rotation of the bearing attached inside a bearing box 187. Meanwhile, the axis ax2 coincides with the rotation shaft of the drive wheel 164. The omnidirectional moving caster 16 has the pair of servo motors 160, and the rotational operation of both of the servo motors can provide change in orientation (steering) of the drive wheel around the axis ax1 and rotational force of the drive wheel around the axis ax2. Then, the axis ax1 and the axis ax2 are spaced with a certain distance and do not intersect each other, and thus if the amount of change in orientation (steering) and the amount of rotation of the drive wheel 164 are appropriately provided, the axis ax1 can be translated in the direction of rotation of the drive wheel 164 while the axis ax1 can be steered in any direction with reference to the position where the drive wheel 164 is set on the road surface. The omnidirectional cart transport mechanism 1 has the pair of the omnidirectional moving casters 16, and thus, the respective axes ax1 as virtual axes are present in determined positions on the vehicle. The relative movements of these two axes ax1 allow the omnidirectional cart transport mechanism 1 to immediately move in any direction as well as to rotate at that position.

The encoder 166 detects a rotation angle around the axis ax1 of the drive wheel 164. A signal indicating the rotation angle detected by the encoder 166 is transmitted to the controller 106 through an output cable not denoted by a reference code. Meanwhile, the servo motor is generally provided with an encoder for detecting a rotation angle of the rotation shaft of the motor. By the pair of servo motors 160 depicted in FIG. 12 as well, the rotation angles of the rotation shafts are detected and transmitted to the controller 106. The controller 106 calculates the rotation angles around the axis ax1 and the axis ax2 of the drive wheel 164 per preset time from the rotation angles of the rotation shafts of these two servo motors 160. The controller 106 can obtain the direction around the axis ax1 of the drive wheel 164 from moment to moment based on the signal received from the encoder 166, and thus can estimate the distance and direction of the translational movement of the axis ax1 relative to a reference point on the vehicle of the AGV 10 at the previous time point in combination with these information. In addition, by taking into account the estimated values obtained from the pair of omnidirectional moving casters 16 and the information on the distances from the surrounding installation and equipment obtained by the laser distance sensor 116, the position of the AGV 10 itself can be presumed. The controller 106 calculates a command to be provided to the servo motors 160 so as to follow a virtual route based thereon to drive the servo motors 160 via the servo driver 162.

A gear housing portion 168 is a housing to house a reduction gear mechanism for reducing the rotation speed in the servo motors 160.

The omnidirectional moving caster 16 includes a first pulley 176, and a rotational force of a bevel gear (not illustrated), for example, that is housed in the gear housing portion 168 is transmitted to the first pulley 176. A second pulley 178 is attached to a shaft portion of the drive wheel 164. A timing belt 182 transmits a rotational force of the first pulley 176 to the second pulley 178. The second pulley 178 is fixed and pivotally supported on the drive wheel 164, and the drive wheel 164 is rotated by a rotational force of the second pulley.

A wheel bracket 186 pivotally supports the drive wheel 164 and the second pulley 178 fixedly supported on the drive wheel 164 via a bearing (not illustrated) about the axis 2. A suspension 184 supports the space between a gear housing portion 174 and wheel bracket 186 with a spring and absorbs the irregularities of the road surface.

In the omnidirectional moving caster 16 illustrated in FIG. 12, the gear mechanisms contained in the gear housing portions 168 and 174 are not especially depicted. The gear housing portion 168 contains a pair of reduction gear mechanisms that are respectively driven by the pair of servo motors 160. Typical example of the reduction gear mechanism is a mechanism in which spur gears of different number of teeth are combined. It is noted that the deceleration mechanism is not limited to the mechanism using gears and may be the mechanism using a timing belt and a chain. However, the gear mechanism is suitable to compactly configure the deceleration mechanism. Moreover, the gear housing portion 174 houses a so-called differential gear mechanism that uses rotation outputs of the pair of reduction gear mechanisms as inputs and extracts the differential output between them. The first pulley 176 is fixed and pivotally supported on the output shaft of the differential gear mechanism (not illustrated).

In FIG. 12, the two servo motors 160 for activating the pair of drive wheels 164 are both attached above the mounting plate 172 at the positions vertical to the road surface. Generally, the servo motors 160 are disposed near the drive wheels 164 to thereby achieve the compact structure. The servo motors 160, however, disposed near the drive wheels 164 are easily affected by the environment of the travel route. In the case where the omnidirectional cart transport mechanism 1 travels on a floor with puddles of wash water especially in a food factory, the servo motors 160 are wet, which may cause electrical fault such as short circuit. Hence, in the present application, the servo motors 160 are disposed at the highest positions of the omnidirectional moving caster 16.

It is noted that as a system for controlling the omnidirectional moving caster 16, a well-known differential gear system and a system in which the wheel axle and the steering shaft of the caster are controlled by separate actuators can be adopted.

In addition, so-called mecanum wheels may be employed as omnidirectional moving mechanism 1 instead of the omnidirectional moving caster 16. A mecanum wheel is equipped with several freely rotatable rollers by motor output attached to the whole circumference of the rim of the wheel at 45 degrees. Alternatively, so-called omni-wheels with small discs around the circumference which are perpendicular to the turning direction may be employed.

FIG. 13 is a schematic perspective view roughly illustrating the entirety of the side guide mechanism 20 as one component of the present application. The output to be finally provided by the side guide mechanism 20 is a function (opening and closing function) of setting or releasing the integration of the AGV 10 with the cart 40 by extending or shortening the distance between the pair of side plates 202 as can be understood from the description up to now. The driving force for opening or closing the space between the side plates 202 is exerted by the servo motor 260. The driving shaft of the servo motor 260 is connected to a rotation shaft 216 via a shaft coupling 214. The rotation shaft 216 is attached with the gear mechanisms 218 (spur gears, for example) on both ends.

In FIG. 13, the pair of side plates 202 are disposed on both sides of the main body of the side guide mechanism 20. The respective side plates 202 are driven in a direction parallel to the feed screws 206 by separate linear-motion mechanisms each composed of the feed screw 206 and the nut portion 220.

The individual side plates 202 on both sides are integrally connected to the nut portions 220 forming the individual linear-motion mechanisms on both sides. Thus, when a rotational force is provided to each of the feed screws 206, the nut portion 220 and the side plate 202 connected thereto move in a direction parallel to the feed screw 206 in accordance with the direction of rotation. Here, the individual feed screws 206 on both sides have central axes placed on the same line while being disposed to have helixes of the screws wound in opposite directions. Thus, even if rotational force in the same direction is applied to the respective screws from the servo motor 260 via the gear mechanism 218, the nut portions 220 on both sides move in the opposite directions to each other. This makes it possible to shorten or extend the distance between the side plates 202 and make the side plates 202 abut against the side surfaces of the cart 40 or uncouple the side plates 202 from the side surfaces of the cart 40.

The motion of each side plate 202 is limited to axial slidable motion by the two slide shafts 204 arranged in parallel to the feed screw 206. Thus, even if a rotational force is provided to the feed screw 206, the side plate 202 does not rotate around the feed screw 206 together with the nut portions 220 connected thereto. The both ends of the feed screws 206 are pivotally supported to side guide frames 209 by the bearings 208.

FIG. 14 is a schematic perspective view roughly illustrating the entirety of the cart lift mechanism 30 as one component of the present application. The output to be finally provided by the cart lift mechanism 30 moves the hook 302 upward and downward to thereby integrate the AGV 10 with the cart 40 or release the integration as can be understood from the description up to now. The driving force for moving the hook 302 upward and downward is exerted by the servo motor 360. The rotational motion of the servo motor 360 is decelerated by a reduction gear 314 and transmitted to the feed screw 306 via the shaft coupling 316. The hook 302 is integrally connected to a nut portion 320 forming the linear-motion mechanism constructed by the feed screw 306 and the nut portion 320. When the feed screw 306 is rotated by the servo motor 360, the nut portion 320 and the hook 302 connected thereto are moved upward or downward depending on the direction of rotation of the servo motor 360. When the hook 302 is moved upward, the hook concavity 302h and the side surface are applied to an aperture portion or an inverted U-shaped groove (not depicted) of the frame member 40f of the cart 40 (see FIGS. 3 and 11) to integrate the AGV 10 with the cart 40. In contrast, when the hook 302 is moved downward, the hook concavity 302h and the side surface are uncoupled from the aperture or the groove provided at the frame member 40f to release the integration.

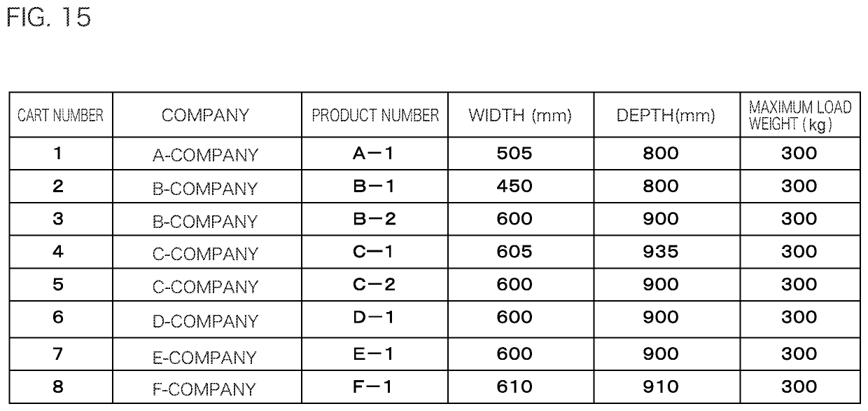

FIG. 15 is a table depicting the dimensions including the width and depth of container carts/platform carts that are currently used. The container carts/platform carts (hereinafter referred to as “cart”) indicate carts without a hand-operated handle. Eight types of carts in total sold by A-Company to F-Company are depicted, and the maximum load weight for all the carts is 300 kg. For example, the cart with a product number A-1 sold by A-Company is 505 mm wide and 800 mm deep. Here, when the width and the depth of the platform cart are defined herein, the length in the short length direction is assumed as a width while the length in the long length direction (longitudinal direction) is assumed as a depth. Now, when the cart with the product number A-1 is coupled to the AGV according to the present application (width (AW)≈600 mm, and depth (AD)≈400 mm), the omnidirectional cart transport mechanism 1 is formed to have an overall length of 1,200 mm (800 mm+400 mm) and an overall width of 600 mm.

The cart with a product number B-2 sold by B-Company is 600 mm wide and 900 mm deep. The width of the cart with the product number B-2 is 600 mm, that is, the same as the width AW of the AGV 10. Accordingly, when this cart is coupled to the AGV 10 according to the present application (600 mm wide and 400 mm deep), the overall length is 1,300 mm (900 mm+400 mm) while the overall width is 600 mm. Thus, it is observed that the cart with the product number B-2 has an overall length greater than the cart with the product number A-1 by 100 mm.

The cart with a product number C-1 sold by C-Company is 605 mm wide and 935 mm deep. The cart with the product number C-1 has a width greater than the width AW of the AGV 10 by 5 mm. Accordingly, when this cart is coupled to the AGV 10 according to the present application (600 mm wide and 400 mm deep), the overall length is 1,335 mm (935 mm+400 mm) while the overall width is 605 mm. Thus the cart with the product number C-1 has an overall length greater than the cart with the product number B-2 by 35 mm and has an overall width greater than the width AW of the AGV 10 by 5 mm.

The width and depth of the cart with a product number D-1 sold by D-Company and the cart with a product number E-1 sold by E-Company are the same as those of the cart with the product number B-2 of B-Company. Accordingly, the overall length of the omnidirectional cart transport mechanism 1 is 1,300 mm (900 mm+400 mm) while the overall width is 600 mm.

The cart with a product number F-1 sold by F-Company is 610 mm wide and 910 mm deep. The width of the cart with the product number F-1 is greater than the width AW of the AGV 10 by 10 mm. Accordingly, when this cart is coupled to the AGV 10 according to the present application (600 mm wide and 400 mm deep), the overall length is 1,310 mm (910 mm+400 mm) while the overall width is 610 mm.

As can be understood from FIG. 15, the width of the cart ranges from 450 mm to 610 mm while the depth of the cart ranges from 800 mm to 935 mm. Accordingly, the difference between the maximum value and the minimum value of the width is 160 mm (610 mm−450 mm) while the difference between the maximum value and the minimum value of the depth is 135 mm (935 mm−800 mm). These values are values to be reflected when the vehicle dimensions of the AGV 10 according to the present application are decided. The standard dimensions adopted by the AGV 10 herein is approximately 600 mm wide and approximately 400 mm deep as described before, and more details will be described below.

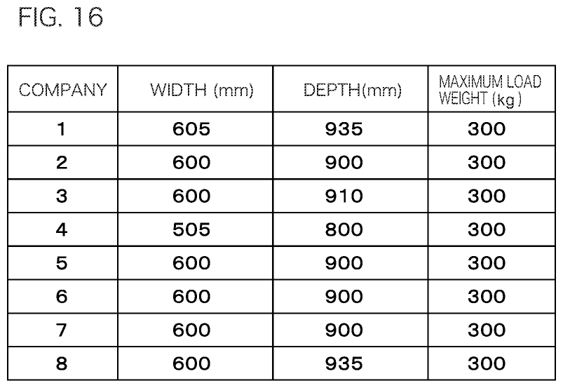

FIG. 16 depicts investigation results of hand carts, that is, carts with a hand-operated handle sold by eight companies. The maximum load weight is 300 kg similarly to FIG. 15. It is observed that the width of the carts offered by the eight companies are commonly approximately 600 mm, and the depth thereof is commonly approximately 900 mm. These numerical values are thus approximately the same as those in the container carts/the platform carts as illustrated in FIG. 15. Thus, the dimensions of the AGV 10 according to the present application can also be applied to the handle carts by referring to the dimensions of the container carts/the platform carts.

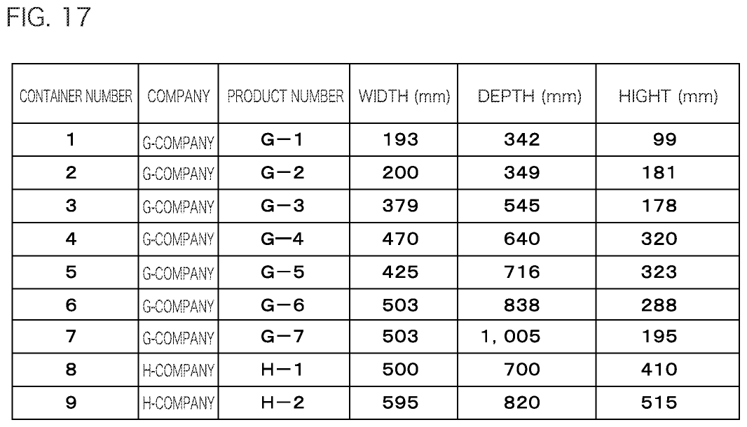

FIG. 17 depicts investigation results of the dimensions of containers that are currently used. The containers are sold by G-Company and H-Company. Seven types of containers are investigated for especially G-Company, though containers of similar dimensions are offered from H-Company as well.

For example, the container with the container number 1 (product number G-1 sold by G-Company) is 193 mm wide, 342 mm deep and 99 mm high, and can have a relatively small capacity to contain commodities and semi-finished products. The container of the product number G-1 can be loaded on the cart with the product number B-1 sold by the B-Company having the smallest dimensions among those depicted in FIG. 15.

Now, the width of containers with product numbers G-1, G-2, G-3, G-4 and G-5 ranges from 193 mm to 425 mm while the depth thereof ranges from 342 mm to 716 mm. The containers with such dimensions are not apparently projected from the contour of the cart if they are loaded on the cart with the product number B-1 sold by the B-Company having the smallest dimensions (450 mm wide and 800 mm deep) among those depicted in FIG. 15.

A container with a container number 6 (product number G-6 of G company) is 503 mm wide and 838 mm deep. When the container is loaded on the cart with the cart number B-1, the container is projected in the depth direction by 38 mm. This problem can be solved by substituting the cart with the cart number 3 (product number B-2) for this cart.

The container with a container number 7 (product number G-7) is 503 mm wide and 1,005 mm deep. There is no carts depicted in FIG. 15 that can load the container with the container number 7 having a depth of 1005 mm without projection from the contour of the cart. This container, however, can be transported by almost all of the carts depicted in FIG. 15, though a large turning radius may occur.

The container with a container number 8 (product number H-1) is 500 mm wide and 700 mm deep while the container with a container number 9 (product number H-2) is 595 mm wide and 820 mm deep. The dimensions of these containers fall within the dimension of the carts with the cart numbers B-2, C-2, D-1, E-1, etc. which allows these containers to be transported without projection from the carts.

Hence, as understood from FIG. 15, FIG. 16 and FIG. 17, the dimension of the cart and the dimension of the container carried by hand without using another equipment such as a hand forklift or the like by a worker are selected to receive each other, not decided independent of each other. This is natural in terms of practicality, usability and safety. Furthermore, since the cart and the container are used by a person, these dimensions have to ensure operability and safety for one person. The dimensions of the omnidirectional cart transport mechanism 1 according to the present application are decided in view of these matters.

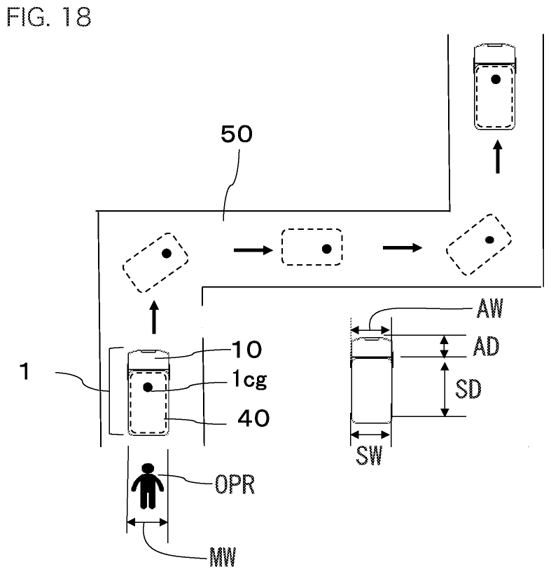

FIG. 18 is a schematic view illustrating a situation in which the omnidirectional cart transport mechanism 1 according to the present application travels on a relatively narrow travel path 50 with corners. The omnidirectional cart transport mechanism 1 travels in a self-navigation system with the cart 40 and the AGV 10 integrated with each other by the side guide mechanism illustrated in FIG. 13 and the cart lift mechanism 30 illustrated in FIG. 14. In other words, the AGV 10 can travel to a destination without a guide material, steering by a person or the like by using a map information storing function, a map creating function, a self-position recognition function and a travel route setting function, etc. that the AGV 10 itself has.

The width AW and the depth AD of the AGV 10 forming the omnidirectional cart transport mechanism 1 are assumed to be 600 mm and 400 mm, respectively, as described before. For convenience of description, the width SW and the depth SD of the cart 40 are assumed to be SW=600 mm and SD=900 mm, respectively. The cart 40 is a cart currently used, not a dedicated cart particularly prepared so as to be suited to the AGV 10 according the present application, and corresponds to the cart with the product number C-2 illustrated in FIG. 15, for example.

The overall length L of the omnidirectional cart transport mechanism 1 including the cart with the cart number C-2 and the AGV 10 in combination is AD+SD=400 mm+900 mm=1300 mm. The overall width D is AW=SW=600 mm. In other words, the ratio between the length and the width of the omnidirectional cart transport mechanism 1 is approximately 2:1.

Here, assuming that the total weight obtained when only eight to twelve tiered containers 42 are loaded on the cart 40, or when a container 42 housing various commodities and semi-finished products is loaded on the cart 40 is, for example 150 kg-300 kg, the center of gravity 1 cg of the omnidirectional cart transport mechanism 1 moves toward the central part of the cart 40, not the side closer to the AGV 10. The closer the turning center of the omnidirectional cart transport mechanism 1 is to the center of gravity 1 cg, the smaller the rotational inertia is, which makes it possible to change the posture (travel direction) of the cart on which transported products are loaded stably and safely with a little driving force though the travel distance is long. In contrast thereto, when the transported products and the cart having a total weight of 150 kg-300 kg swing around a partial region of the AGV 10 within, large rotary inertia occurs, which requires a great driving force at a start of movement. In addition, not only a great driving force is required to stop the transported products and the cart that gain impetus once, but also such a movement cannot be controlled. Hence, if heavy products placed on a cart are transported, the AGV preferably travels while shifting the turning center to the cart. Here, the omnidirectional cart transport mechanism 1 can literally travel in all directions and can immediately move directly horizontally, and thus can turn the cart around a turning center at any position. As the distance from center of gravity 1 cg of the turning center to the rear end of the AGV 10 is shorter, the cart 40 and the AGV 10 are less likely to collide with a wall and equipment around them if the cart 40 and the AGV 10 are rotated in an integrated state with reference to the turning center on the cart 40. Thus, it is desirable that the width AW and the depth AD of the AGV 10 are made as small as possible.

Now, it is said that the shoulder width of an ordinary person is 450 mm-460 mm. It is also said that the width of a passage that allows one person to pass is 520 mm-600 mm at minimum. It may be considered that the width of a passage and an entrance through which an ordinary person commonly transports the transported good using a cart as well as the size of the turning space are decided roughly based on these values including an empirical rule.

As described above, the present inventors obtain such findings that the width AW and the depth AD of the AGV 10 are respectively selected as AW=520 mm-700 mm and AD=340 mm-480 mm, more preferably approximately AW≈600 mm and approximately AD≈400 mm in view of the miniaturization of the omnidirectional cart transport mechanism 1, traveling on a relatively narrow passage through which a person currently passes for transportation with a cart, and the dimensions of the container carts and the container that are currently used.

The width AW of the AGV 10 can be made shorter than 600 mm. The AGV 10, however, is required to be mounted with a motor, a reduction gear, a secondary battery, communication equipment, etc. and is thus required to ensure some extent of capacity. Hence, if the width of the AGV 10 is narrowed down to 460 mm that approaches the length of a person's shoulder, the depth AD thereof has to be increased to ensure a certain amount of capacity. If the depth AD is made larger, a turning radius upon traveling also becomes larger, resulting in provision of a wide passage.

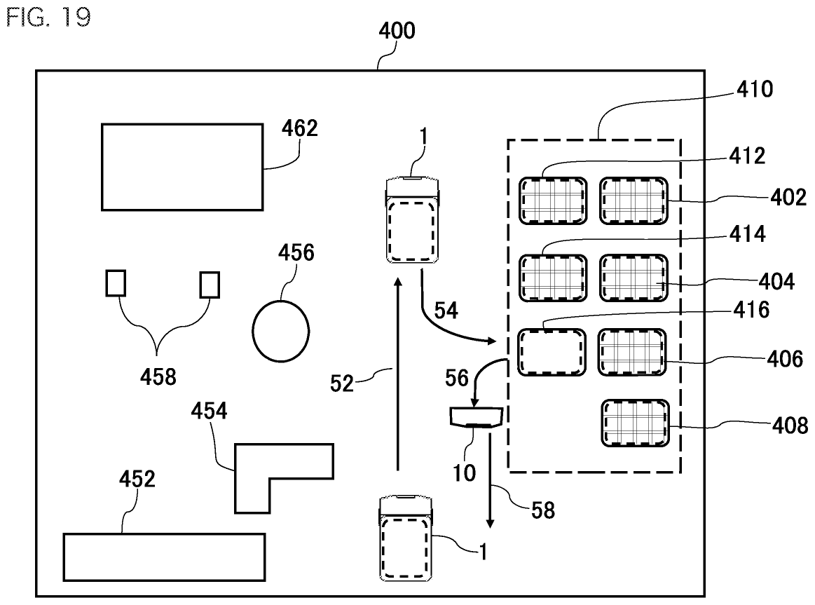

FIG. 19 is a schematic diagram illustrating a behavior until the omnidirectional cart transport mechanism 1 illustrated in FIG. 1 places loads in a preset container housing area. In the premises 400 illustrated in FIG. 19, structures such as various devices, mechanical equipment, pillars, etc. are assumed to be installed. The two-dimensional or the three-dimensional shapes/dimensions of the structures of various equipment or the like installed in the premises 400 are important sources of information for traveling of the omnidirectional cart transport mechanism 1. For the convenience of description herein, such devices are objects to be detected and recognized for the omnidirectional cart transport mechanism 1, and referred to as objects to be recognized, and denoted by reference codes 452, 454, 456, 458 and 462.

FIG. 19 depicts a state where the omnidirectional cart transport mechanism 1 has already been finished to store cart containers 402, 404, 406, 408, 412 and 414 including the cart 40 and containers to be loaded in a housing area 410 and is about to store a cart container 416.

The omnidirectional cart transport mechanism 1 travels to a predetermined position within the housing area 410 while detecting and confirming the presence of the objects to be recognized 452, 454, 456, 458 and 462 following map information/location information, etc. previously stored in the controller 106.

When the omnidirectional cart transport mechanism 1 stores the cart container 416 in the housing area 410, the controller 106 has information on the completion of storing the cart containers 402 to 414 and information on the cart container 416 as a next object to be stored.

It is further possible to recognize that the cart container 416 is to be stored adjacent to the cart container 414 and in front of the cart container 406 based on the number of cart containers and the housing state in the housing area 410 by the laser distance sensor 116.

In FIG. 19, the omnidirectional cart transport mechanism 1 travels along a traveling route 52. The two-dimensional information on the traveling route 52 has previously been stored in the controller 106. However, the omnidirectional cart transport mechanism 1 performs self-navigation control during traveling by measuring distances between the objects to be recognized 454, 456, etc. and the housing area 410 or the distance from the cart containers 412, 414, etc. that have already been stored by the laser distance sensor 116.

When traveling to a position between the object to be recognized 462 and the cart container 412, the omnidirectional cart transport mechanism 1 stops at once and moves back to the position where the cart container 416 is easily stored along a traveling route 54. The AGV 10 is generally followed by the cart 40, though this order is reversed on the traveling route 54. When the cart container 416 is stored in a predetermined position, the AGV and the cart 40 are uncoupled from each other, and only the AGV returns to the starting point through a traveling route 58. It is noted that uncoupling of the AGV 10 from the cart 40 is performed by the controller 106 detecting that the cart container 416 has arrived at a predetermined position based on the data from the laser distance sensor 116 (see FIG. 5) and issuing a signal for releasing the integration of the AGV 10 with the cart 40 to the side guide mechanism 20 and the cart lift mechanism 30.

As described above, the side guide mechanism and the cart lift mechanism with a relatively simple structure according to the present application enable automatic coupling of the AGV to the cart to establish integration, and automatic uncoupling of the AGV from the cart to easily release the integration. The carts currently used by a person can be used as they are, which eliminates the need for newly providing a loading device for loading a container from a cart to an AGV or an unloading device for unloading a container from the AGV. Furthermore, the AGV is suited to the dimensions of the carts and the containers that are daily used frequently, which is very practical. Moreover, since the projected dimensions of the AGV 10 on the road surface are set to values suited to footprints when a person walks, the AGV 10 can travel on the existing passages and entrances conventionally used to transport products by pushing or drawing carts as they are without providing wide travel path and turning space specifically designed to the AGV.

In addition, even if transporting heavy products placed on a cart, the AGV can shift the turning center to the cart, or move the turning center during traveling by an omnidirectional traveling capability, which makes it possible to turn the cart and the AGV in an integrated manner with a little driving force in a relatively small space even at a cranked corner of the passage.

It is to be understood that the embodiments disclosed here is illustrative in all respects and not restrictive. The scope of the present invention is defined by the appended claims, and all changes that fall within the meanings and the bounds of the claims, or equivalence of such meanings and bounds are intended to be embraced by the claims.

What is claimed is:

1. An omnidirectional cart transport mechanism comprising:
an automatic guided vehicle that includes a drive wheel and a drive mechanism for driving the drive wheel, and travels on a road surface by driving the drive wheel using the drive mechanism;
a side guide mechanism that includes a pair of side plates movable in a first direction of approaching or separating from each other, and guides a cart to be coupled to the automatic guided vehicle to a coupled position by bringing the pair of side plates closer to each other with the cart positioned between the pair of side plates; and
a cart lift mechanism that lifts a coupled portion of the cart guided to the coupled position.

2. The omnidirectional cart transport mechanism according to claim 1, wherein a part of a reaction force loaded on the cart lift mechanism when lifting the coupled portion is loaded on the drive wheel in order to increase a frictional force between the drive wheel and the road surface.

3. The omnidirectional cart transport mechanism according to claim 1, wherein a length in the first direction of the automatic guided vehicle is 480 mm to 700 mm while a length in a second direction intersecting the first direction of the automatic guided vehicle is 320 mm to 480 mm.

4. The omnidirectional cart transport mechanism according to claim 1, wherein
a force lifting the coupled portion by the cart lift mechanism is provided based on a set value for a target torque or a torque limitation of a servo motor for driving the cart lift mechanism, and
the set value is set based on a weight of the automatic guided vehicle, an total transport weight including the cart, a structure, a material or a dimension of the servo motor or the drive wheel, or a towing force by the automatic guided vehicle.

5. The omnidirectional cart transport mechanism according to claim 1, wherein
the cart lift mechanism includes a hook to be engaged with the coupled portion of the cart, and is coupled to the cart by lifting the coupled portion in a state where the hook is engaged with the coupled portion.

6. The omnidirectional cart transport mechanism according to claim 1, wherein
the drive mechanism includes a servo motor attached to a mounting plate, a gear mechanism driven by the servo motor, a first pulley pivotally supported by an output shaft of the gear mechanism, a second pulley pivotally supported by the drive wheel, and a belt hanging across the first pulley and the second pulley.

7. The omnidirectional cart transport mechanism according to claim 6, wherein the servo motor is provided above the mounting plate at an upper position to a road surface on which the drive wheel travels.

8. The omnidirectional cart transport mechanism according to claim 1, wherein
the side guide mechanism includes a servo motor, a rotation shaft connected to a driving axis of the servo motor via a shaft coupling, a gear mechanism connected to the rotation shaft, and a pair of linear-motion mechanisms driven by the gear mechanism, wherein
each of the pair of linear-motion mechanisms includes a feed screw to which a rotational force is applied by the gear mechanism, a nut portion attached to the feed screw, and a slide shaft on which the nut portion slides,
a helical direction of the feed screw provided in one of the linear-motion mechanisms is opposite to a helical direction of the feed screw provided in the other one of the linear-motion mechanisms, and
the pair of side plates are attached to the respective nut portions included in the pair of linear-motion mechanisms and are configured to move in the first direction of approaching or separating from each other by rotation of the servo motor.
